(19) United States
(12) Patent Application Publication
(10) Pub. No.: US 2025/0355645 A1
(43) Pub. Date: Nov. 20, 2025

(54) SYSTEM AND METHODS FOR CROSS PLATFORM ENGAGEMENT ORIENTED ARTIFICIAL INTELLIGENCE ENHANCED PROGRAMMING

(71) Applicant: QOMPLX LLC, Reston, VA (US)

(72) Inventors: Jason Crabtree, Vienna, VA (US); Richard Kelley, Woodbridge, VA (US); Jason Hopper, Halifax (CA); David Park, Fairfax, VA (US)

(21) Appl. No.: 18/668,139

(22) Filed: May 18, 2024

(51) Int. Cl. G06F 8/38; G06F 8/10; G06F 8/35; G06F 40/205

(52) U.S. Cl. CPC G06F 8/38; G06F 8/10; G06F 8/35; G06F 40/205

(57) ABSTRACT

A platform for dynamically generating application experiences. The platform comprises a design management system, an agent orchestration system, an analytics system, a model management system, a user management system, and databases for storing design elements and templates. The design management system provides a portal for application owners/designers to create UX/UI designs, allowing them to select design elements from a set of categories or templates. The platform gathers existing websites/applications to identify common design patterns, stored in a design catalogue database, and suggests historical interfaces for design exploration. It enables the generation of templated applications that integrate with legacy systems. The agent orchestration system parses user specifications, selects generative AI systems, and generates UX/UI content based on the specifications. The analytics system collects and analyzes data to provide insights for improving UX/UI design and optimizing website performance. The model management system trains and maintains generative AI models used for content generation.

### CROSS-REFERENCE TO RELATED APPLICATIONS

Priority is claimed in the application data sheet to the following patents or patent applications, each of which is expressly incorporated herein by reference in its entirety: None.

### BACKGROUND OF THE INVENTION

### Field of the Art

The present invention is in the field of online user experience management and augmentation, and more particularly to providing dynamic generation of user interface or user experience content enhanced with artificial intelligence.

### Discussion of the State of the Art

While Copilot features in Github, Gitlab, etc. are now able to provide code suggestion and generation, current offerings remain quite limited in scope and are not generally related to “cross platforming” (e.g., device type like phone to VR to laptop to workstation), cross operating system (e.g. Windows to Linux), or cross language (e.g., Python to Scala or Java to Rust). Some cross platforming requires several such transformations (e.g., web to iPhone) where designers must consider application/experience design, functionality, and then code. This may involve multiple extraction, schematization and representation, normalization, knowledge curation, modeling, and generation steps especially when bringing together, or diversifying, content from or to multiple interaction environments with prospective or current users.

User interface (UI) and/or user experience (UX) developers are charged with structuring content in a way that is visually appealing and logical to navigate for users. This has led to many common conventions such as hamburger menus, sidebars, hyperlink images, and many common design patterns. There are several challenges with this. First is that for larger projects it takes an entire team of designers to do the UX, and an entirely different team to do UI. These can be slow processes requiring iterative checks, user testing, experimentation, development, ultimately making it a very costly process. The current UI/UX design and build process supports so-called “responsive design” for variations in devices and screen sizes, but is unable to accommodate dynamic or custom features to support a particular user's needs, preferences, or natural approach. It can only yield a ‘one size fits all’ solution.

What is needed is a platform for dynamic generation of application experiences which leverages state of the art machine learning and artificial intelligence tools to enhance and foster engagement oriented programming.

### SUMMARY OF THE INVENTION

Accordingly, the inventor has conceived and reduced to practice, a platform for dynamically generating application experiences and machine-aided processes. The platform comprises a design management system, an agent orchestration system, an analytics system, a model management system, a simulation engine, a planning system, a user management system, and databases for storing knowledge, design elements and templates. The design management system provides a portal for application owners/designers to create UX/UI designs and user engagement processes for human and ai agents, allowing them to select design elements from a set of categories, flows or templates. The platform gathers existing websites/applications to identify common design patterns, stored in a design catalogue database, and suggests historical interfaces for design exploration. It enables the generation of templated applications that integrate with legacy systems or processes. The agent orchestration system parses user or system provided process specifications, selects models or simulations or generative AI systems, and generates UX/UI content based on the specifications based on their satisfaction of rules or an objective function for system adherence to goals. The analytics system collects and analyzes data to provide insights for improving UX/UI design and optimizing website or application performance across at least one device type or user engagement mode. The model management system trains and maintains AI models used for content evaluation or generation in data collection, knowledge curation, analytics, or output generation.

According to a preferred embodiment, computing system for dynamic generation of application experience employing a dynamic application experience generation platform is disclosed, the computing system comprising: one or more hardware processors configured for: receiving a user specification comprising one or more design elements, user preference configuration document, or templates associated with user experience (UX) or user interface (UI) content; parsing the user specification to select one or more generative artificial intelligence (AI) systems to be used to generate the presented or intermediate UX or UI content; engineering one or more prompts for the selected generative AI systems based on the user specification; submitting the one or more prompts as input to the selected generative AI systems; and outputting generating UX or UI content based on the submitted prompts.

According to another preferred embodiment, a computer-implemented method executed on a dynamic application experience generation platform for dynamic generation of application experience is disclosed, the computer-implemented method comprising: receiving a user specification comprising one or more design elements, user preference configuration document, or templates associated with user experience (UX) or user interface (UI) content; parsing the user specification to select one or more generative artificial intelligence (AI) systems to be used to generate the presented or intermediate UX or UI content; engineering one or more prompts for the selected generative AI systems based on the user specification; submitting the one or more prompts as input to the selected generative AI systems; and outputting generating UX or UI content based on the submitted prompts.

According to another preferred embodiment, a system for dynamic generation of application experience employing a dynamic application experience generation platform is disclosed, comprising one or more computers with executable instruction that, when executed, cause the system to: receive a user specification comprising one or more design elements, user preference configuration document, or templates associated with user experience (UX) or user interface (UI) content; parse the user specification to select one or more generative artificial intelligence (AI) systems to be used to generate the presented or intermediate UX or UI content; engineer one or more prompts for the selected generative AI systems based on the user specification; submit the one or more prompts as input to the selected generative AI systems; and output generating UX or UI content based on the submitted prompts.

According to another preferred embodiment, non-transitory, computer-readable storage media having computer executable instruction embodied thereon that, when executed by one or more processors of a computing system employing a dynamic application experience generation platform for dynamic generation of application experience, cause the computing system to: receive a user specification comprising one or more design elements, user preference configuration document, or templates associated with user experience (UX) or user interface (UI) content; parse the user specification to select one or more generative artificial intelligence (AI) systems to be used to generate the presented or intermediate UX or UI content; engineer one or more prompts for the selected generative AI systems based on the user specification; submit the one or more prompts as input to the selected generative AI systems; and output generating UX or UI content based on the submitted prompts.

According to an aspect of an embodiment, the one or more hardware processors are further configured for: computing a clarity score for the user specification, wherein the clarity score is based on a plurality of factors; comparing the computed clarity score with a predetermined threshold value: wherein if the computed clarity score is less than the threshold value, collecting more design information from a designer to be added to the user specification; and wherein if the computed clarity score matches or exceeds the threshold value, allowing the parsing of the user specification.

According to an aspect of an embodiment, the clarity plurality of factors comprises a defined goal, available context, specificity, content examples, and language.

According to an aspect of an embodiment, the generated UX or UI content comprises computer code.

According to an aspect of an embodiment, the generated UX content comprises a UX workflow.

According to an aspect of an embodiment, the UX or UI content is generated for a plurality of devices and platforms.

According to an aspect of an embodiment, the plurality of devices and platforms comprise a computer, a mobile computing device, augmented reality or virtual reality devices, gaming platforms, and wearable devices.

According to an aspect of an embodiment, the one or more design elements comprises colors, shapes, formats, functions, widgets, cards, tiles, panels, tabs, dropdown menus, accordion menus, sliders, form elements, icons, progress indicators, and dialog boxes.

According to an aspect of an embodiment, the user specification is defined using a domain-specific language (DSL) that includes primitives for specifying experiential elements, content elements, design elements, cross-platform targeting, AI integration, and analytics & optimization.

According to an aspect of an embodiment, the DSL includes primitives for specifying how generative AI models should be used for content creation, experience personalization, and predictive UX optimizations.

### BRIEF DESCRIPTION OF THE DRAWING FIGURES

FIG. 1 is a block diagram illustrating an exemplary system architecture for dynamic generation of application experiences, according to an embodiment.

FIG. 2 is a block diagram illustrating an exemplary aspect of dynamic application experience generation platform, a design management system.

FIG. 3 is a block diagram illustrating an exemplary aspect of dynamic application experience generation platform, an agent orchestration system.

FIG. 4 is a block diagram illustrating an exemplary design workboard which may be implemented by dynamic application experience generation platform, according to an aspect.

FIG. 5 is a block diagram illustrating exemplary clarity factors which may be used for determining a clarity score associated with a user specification for UX/UI content, according to an aspect.

FIG. 6 is a flow diagram illustrating an exemplary method for generating UX/UI content and/or workflows using a user specification, according to an embodiment

FIG. 7 is a flow diagram illustrating an exemplary method for generating UX/UI content and/or workflows using a user specification and feedback, according to an embodiment.

FIG. 8 is a flow diagram illustrating an exemplary method for generating UX/UI content and/or workflows using a user specification wizard, according to an embodiment.

FIG. 9 is a flow diagram illustrating an exemplary method for generating UX/UI content and/or workflows using a user specification chatbot, according to an embodiment.

FIG. 10 is a flow diagram illustrating an exemplary method for providing dynamic UX/UI modification in real-time based on a user request, according to an embodiment.

FIG. 11 is a flow diagram illustrating an exemplary method for generating UX/UI content and/or workflows using a user specification and a clarity score, according to an embodiment.

FIG. 12 illustrates an exemplary computing environment on which an embodiment described herein may be implemented.

### DETAILED DESCRIPTION OF THE INVENTION

The inventor has conceived, and reduced to practice, a platform for dynamically generating application experiences. The platform comprises a design management system, an agent orchestration system, an analytics system, a model management system, a user management system, and databases for storing design elements and templates. The design management system provides a portal for application owners/designers to create UX/UI designs, allowing them to select design elements from a set of categories or templates. The platform gathers existing websites/applications to identify common design patterns, stored in a design catalogue database, and suggests historical interfaces for design exploration. It enables the generation of templated applications that integrate with legacy systems. The agent orchestration system parses user specifications, selects generative AI systems, and generates UX/UI content based on the specifications. The analytics system collects and analyzes data to provide insights for improving UX/UI design and optimizing website performance. The model management system trains and maintains generative AI models used for content generation.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Conceptual Architecture

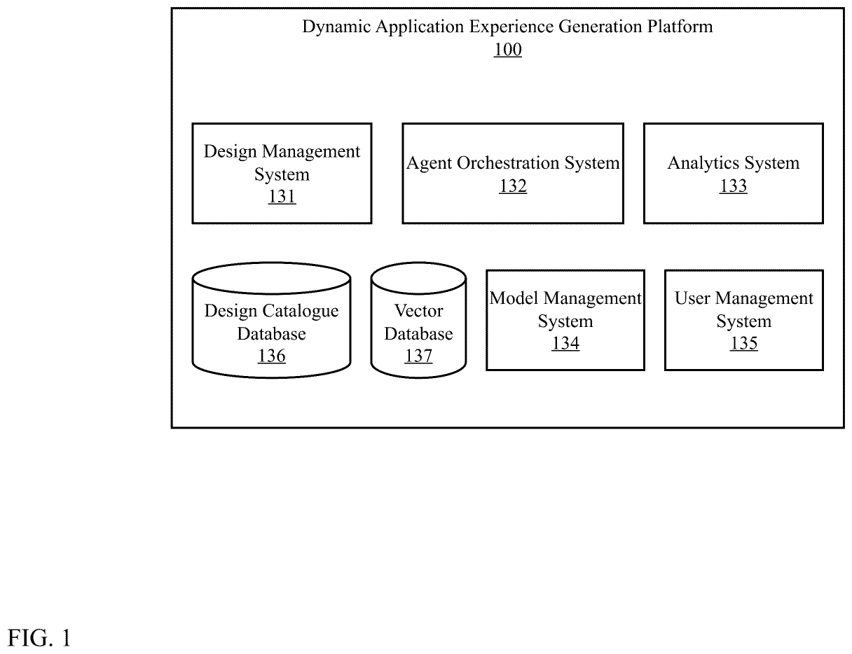

FIG. 1 is a block diagram illustrating an exemplary system architecture for dynamic generation of application experiences, according to an embodiment. According to the embodiment, dynamic application experience generation platform 100 comprises a design management system 131, an agent orchestration system 132, an analytics system 133, a model management system 134, a user management system 135, and one or more databases for storing design elements and templates 136 and a vector database 137 for storing vectorized data such as, for example, user specification, design elements/templates, etc.

According to the embodiment, design management system 131 is present and configured to provide a portal for application owners/designers to create and design a UX/UI for an application or website. According to an aspect of an embodiment, an owner/designer can select from a set of prospective categories or sites they like. For example, the set of categories/sites/templates/elements may be implemented as a visual workboard for design elements which allows users to browse and select design elements that appeal to them or their website/application use case. This could be tagged for things like “design”, “color”, “layout”, “function”, “imagery”, “workflow”, etc. This may be performed manually (e.g., via a wizard) or via interrogation (i.e., chatbot prompts) to get sufficient user clarity through a series of interactions. The clarity of the user specification may be scored or otherwise analyzed to determine if there is sufficient clarity for generative AI prompt generation/engineering and feedback loop purposes. According to an aspect, a clarity score may be determined based on how clear and specific the user specification is.

Platform 100 may gather a collection of existing websites/applications that represent a variety of design styles and functionalities. In some implementations, one or more AI systems may be configured to analyze these websites/applications to identify common design patterns, elements, and layouts that can be used as templates. These design patterns, elements, and layout may be stored in a design catalogue database 136. Design catalogue database 136 may store templatized versions of existing websites/applications. Design catalogue database 136 may store the raw, non-templatized websites/applications. Design catalogue database 136 may store a plurality of design elements such as, for example, colors, shapes, formats, functions, widgets, cards, tiles, panels, tabs, dropdown menus, dialog boxes/windows, accordion menus, sliders, form elements, icons, progress indicators. These design elements can be used individually or combined to create more complex and interactive user interfaces. Design management system 131 may utilize a user-friendly interface allowing designers to easily browse and search the catalogue of templates/design elements. This can include features such as filtering by category, style, and functionality to help designers find the relevant templates.

The databases for storing design elements and templates 136 may also include a repository for storing domain-specific language (DSL) code. This repository could contain reusable DSL code snippets, templates, and libraries that designers can leverage when defining new experiences. The repository could also include version control and collaboration features, allowing multiple designers to work on the same DSL code and track changes over time.

In some implementations, an AI system may be used to catalogue and suggest historical templatized interfaces and concepts that are part of an ongoing “generative content” catalogue which may be stored in design catalogue database 136. This can not only be used for design explorations/suggestions in the visual editing/suggestion workflows, but may inspire alternate process definition elements. For example, platform can provide expanded capabilities in cross-platform and human-machine team application generation to generate and design applications that integrate with various legacy systems such as Appian, Pega System, and ServiceNow. These legacy system are known for their ability to define forms, workflows, and other components using Business Process Notation Language and similar languages. Platform 100 can uses these definitions and inputs to generate templated applications that meet the specifications provided by the user. This approach would allow for rapid development and deployment of applications that integrate with existing systems and adhere to established workflows and processes.

It should be appreciated that platform 100 may be configured for the ability to do “language shifts” for legacy applications where there is some need to shift. For example, Cobalt core banking applications may require a language update as there are few Cobalt developers left and they are costly to employ. Translation of applications by merging process expectations, design expectations, and even things like Binary Executable Transform based execution analysis, (with optional JITing emulation instruction for testing validation, stability, functionality, and security) can improve results when used in an interactive/orchestrated fashion.

Similarly, there are a lot of case where old software is not optimized for newer chips (e.g., the AMD Threadripper 3D chips can't use all their cores in a lot of gaming software). As another example, Autocad is not well optimized (basically single threaded in some cases). It should be appreciated that this composite “application reimaging” can work to preserve experience or function elements by using at least one of the generation/validation model steps proposed herein. Furthermore, explanations of limitations in the software would be valuable to identify (e.g., user just wrote this in a way that is single threaded—did you intend to? Can I optimize this for a specific hardware platform for you?). This could be returned as text-to-voice or generate a video to explain it to the user with an avatar.

In an embodiment, a generative AI model may be configured for generating interfaces and managing data transfer contracts. In such an embodiment, platform 100 may comprise data contract enforcement mechanisms and data registries. For interface generation, generative AI can help create user interfaces for applications, websites, or other systems. It can generate UI components based on specifications or requirements, which can be particularly useful for rapid prototyping or creating consistent UI designs. Regarding data transfer contracts, Gen AI can assist in creating or managing contracts that govern the transfer of data between different parties or systems. This includes formats like Avro or Protobufs, which are used to serialize data for efficient transmission and storage. A data transfer contract is a legal agreement that governs the transfer of data from one party to another. These contracts are often used when sensitive or personal data is being transferred, such as in the context of data processing agreements, international data transfers, or sharing data between organizations. Data transfer contracts typically include provisions related to the following: data protection, data security, data processing, data subject rights, data retention, data breach notification, liability and indemnification, and jurisdiction and governing laws. Data transfer contracts are important for ensuring that data transfers comply with legal requirements and that the rights of data subjects are protected.

The implementation of data contracts can vastly improve cross platform application development workflows and code generation when combined with generative AI techniques. According to an aspect, data contracts may be decentralized. This ensures that teams with diverse data uses or multiple engineering teams are not hindered and facilitate healthy, timely evolution of data products. Data producers should be responsible for data contract enforcement. If there's no enforcement of the contract on the producer side then it is not a contract and downstream teams cannot utilize or plan appropriately. Contract data should be available to all consumers (e.g., transparent access to schema and structure to the data user and not only the data platform). Other services should be able to consume versioned contract data and data descriptions separate from the data. Data contracts may be public to authenticated/authorized users and services. Implementation must support evolving contracts over time without breaking downstream consumers, which necessitates versioning and strong change management. This again begins at the producer so that downstream teams can plan to version hop as the producer releases new and enhanced variants. Data contracts must always cover both the schemas and semantics. At the most basic level, contracts cover the schema of entities and associated events, while preventing backward incompatible changes like dropping a required field. In application programming interface (API) design, altering the APIs behavior is considered a breaking change even if the API signature remains the same. Here, this means contracts must contain additional metadata beyond the schema, including descriptions, value constraints, and so on.

Data contracts should not hinder iteration speed for developers. Defining and implementing data contracts should be handled with tools already familiar to backend developers, and enforcement of contracts may be automated as part of the existing CI/CD pipeline. The implementation of data contracts reduces the accumulation of tech debt and tribal knowledge at a company, having an overall net positive effect on iteration speed. Data contracts, when used properly, enhance, and should not hinder iteration speed for data scientists. Access to raw (non-contract) production data should be available in a limited “sandbox” capacity to allow for exploration and prototyping. However, users should avoid pushing prototypes of unsupported schemas or semantics into production directly. Once again, the implementation of data contracts reduces the accumulation of tech debt and tribal knowledge at a company, having an overall net positive effect on iteration speed in the client-facing production services.

Contracts are abstractions. Reading directly from databases and copying into data platforms directly (CDC) is an anti-pattern. Data contracts may be used to decouple the internal details of the database to provide consumers with the data they actually need to do their jobs internal to the engineering organization or within the ultimate client/user base.

According to the embodiment, agent orchestration system 132 is present and configured to parse a user specification to select the appropriate generative AI systems (also referred to herein as agents) to generate the UX/UI content (either presented or intermediate UI/UX) based on the user specification. Agent orchestration system 132 may perform prompt engineering tasks to create one or more prompts based on the user specification and the selected generative AI systems to be submitted to the selected generative AI systems. The selected agents may then generate UX/UI content based on the prompt. In some embodiments, this process may be an iterative one, wherein the one or more selected generative AI systems generate the content as defined by the user specification and the designer and/or industry experts can provide feedback about the performance of the generated UX/UI content. This feedback may be used to generate a new design and the designer may select from the available designs the one they wish to continue using.

According to the embodiment, analytics system 133 is present and configured to collect, process, analyze, and interpret data to provide insights that can help application owners and designers and/or application users to make informed decisions related to generated UX/UI content. Analytics system 133 can collect data from various sources, such as databases, files, application programming interfaces (APIs), third-party services, and streaming data sources. Exemplary data that might be collected can include but is not limited to, load times, observability, conversion rates, site metrics, user demographic or contextual factors, user behavior, usage patterns, and latency, to name a few. For example, analytics system 133 may use tools similar to Google Analytics, Hotjar, or custom tracking scripts to collect data on load times, observability, conversion rates, site metrics, demographic/contextual factors, user behavior, etc. The system may integrate APIs of data pipelines to gather data from different sources and formats into a centralized data warehouse or data lake.

Data analytics system 133 may clean and preprocess the collected data to handle missing values, outliers, and inconsistencies. Collected data may be transformed into a format suitable for analysis, such as aggregating data points over time intervals or user sessions, or vectorizing data (using an embedding model) for processing by one or more artificial intelligence (AI) systems (e.g., neural network, transformer model, etc.). Analytics system 133 may use statistical analysis and machine learning techniques to analyze the data and extract insights. For example, AI may be used to identify patterns, trends, correlations, and anomalies in the data related to UX/UI performance and/or user behavior. In some embodiments, analytics system 133 may be configured to create visualizations (e.g., charts, graphs, dashboards, etc.) to represent the analyzed data and insights. For example, system may visualize metrics like load times, conversion rates, user demographics, and behavior patterns to make them easier to understand and interpret.

The collected and analyzed data may be used to generate insights and recommendations based on the analysis to improve UX/UI design, optimize website performance (based on one or more optimization factors or goals), and enhance user experience. For example, the system may generate actionable recommendations for improving conversion rates, reducing latency, and addressing user needs/preferences. In some implementations, the actionable recommendations may be implemented dynamically wherein the changes/optimizations are automatically applied in real-time or near real-time to enhance the experience of the application user. Analytics system 133 may continuously monitor website/application performance and user interactions to identify areas of improvement. System may implement A/B testing and other optimization strategies to test and validate proposed changes based on data-driven insights. For example, individual design elements might be swapped (e.g., button colors or specific images or terms) to look at optimization of conversion funnels for specific elements linked to site value, performance, profitability, and/or the like.

A model management system 134 is present and configured to obtain, train, and/or maintain one or more generative AI or ML models which may be used by agent orchestration system 132 to generate UX/UI content, according to an embodiment. For the use case directed to curating a user's experience with the Internet there are several types of generative AI systems that could be used to curate and render content on a custom web page (or some other type of representation such as a mobile app render, an AR/VR environment, etc.). One of many possible examples can include a conditional image generation system which generates images based on conditional inputs such as, for example, generating different versions of a product image based on user preferences. The one or more generative AI models which may be implemented by platform 100 may be trained on a plurality of training data comprising design elements, websites and applications, functionalities, various coding languages (e.g., JavaScript, Swift, HTML, CSS, etc.), design templates, user and expert feedback, and/or the like.

A user management system 135 is present and configured to implement user management features, such as user accounts and permissions, to allow for collaboration among team members. Designers can be enabled to share design projects and collaborate on them within the design portal.

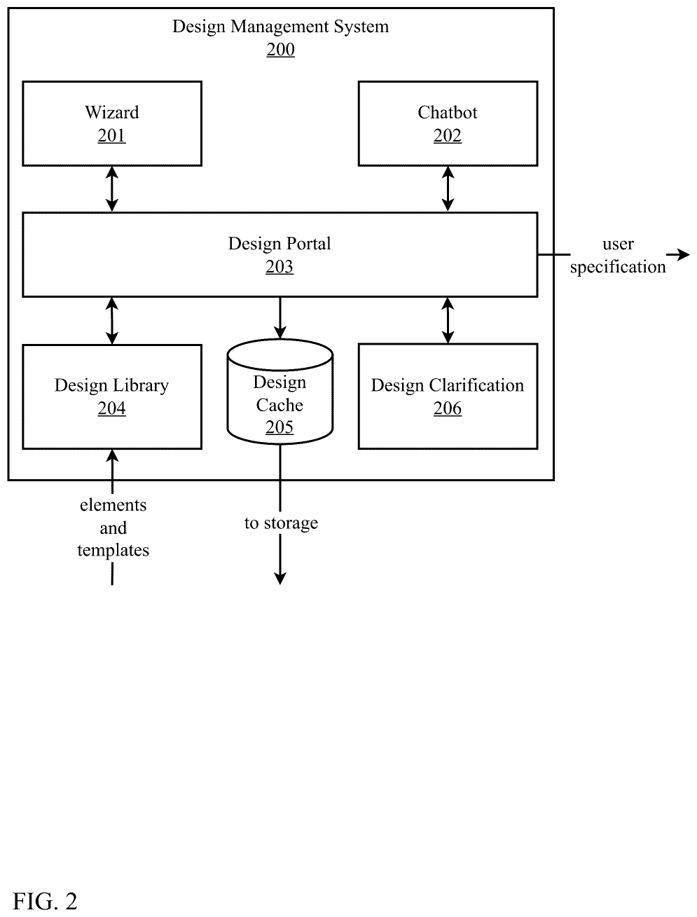

FIG. 2 is a block diagram illustrating an exemplary aspect of dynamic application experience generation platform, a design management system 200. According to the aspect, design management system 200 comprises a design portal 203, a design library 204, a design clarification subsystem 206, and a design cache 205. Design portal 203 may be configured to allow users to select from a set of prospective categories or sites they like in order to create a user specification which captures all the design elements, functionality, and purpose of generated UX/UI content for a website or application. In some implementations, a user can submit a user preference configuration document which may be a file or set of files that explicitly defines the preferences, settings, and customization options for a particular user or user segment. This document allows designers to tailor the generated UX/UI content to specific needs, interests, and behaviors of different users. A user preference configuration document may comprise the following types of information: user profile data, content preferences, layout and design preferences, interaction preferences, personalization settings, accessibility settings, device and platform preferences, and/or data privacy and security settings.

At the design portal, a user (e.g., website/application owner/designer) can interact with design library 204 to browse and view various design elements. This may be performed manually via a wizard 201 or via interrogation using, for example, chatbot 202 prompts. A wizard is a user interface that leads a user through a sequence of small steps, like a dialog box to configure a program for the first time. Wizard 201 may be configured to lead the user through the design selection process by asking the user for input related to UX/UI design implementation. For example, wizard 201 may ask the user to select a defined goal from a list of potential goals for the UX/UI content and provide any available context, specifics, or examples. In some implementations, a chatbot 202 may be configured to perform the functionality of wizard 201, but in a conversational manner. In some implementations, chatbot 202 may be a based on a transformer model, LLM, or mamba model. The answers provided by the user to the chatbot may be used to choose a set of or specific design elements. For example, wizard or chatbot may obtain from the user a type of website/application they want to create and a set of templates associated with the type may be retrieved from design catalogue database 136 and displayed to the user via design library 204.

According to the aspect, design library 204 is configured to provide a graphic user interface (GUI) which presents a plurality of design elements and/or templates which a user may peruse and select from. The displayed set of elements/templates may be arranged in a “workboard” layout where a plurality of design elements and templates may be organized and displayed to the user so that the user can browse, search, and preview various design elements/templates. For example, users may search by website/application type such as, for example, e-commerce websites/applications, social media platforms, content management system (e.g., blogs and other digital content), online learning platforms, new websites/applications, entertainment platforms (e.g., video or music streaming), gaming platforms, travel and booking, financial services, health and fitness, and/or the like. If a user wishes to create the UX/UI for an online learning platform, then design management system 200 may retrieve all templates associated (e.g., tagged) with online learning websites or applications from design catalogue database 136 and display them to the user via design library 204.

The responses to wizard/chatbot, the design elements and/or templates selected by the user, the users interaction with the workboard (e.g., search queries, mouse clicks, hover time, etc.), and any available user preferences (e.g., retrieved from a preference database or submitted directly by the user) may be included in a user specification. It should be appreciated that a user specification may comprise more or less information than what was described above. A user specification may be sent to a design clarification subsystem 206 which is configured to assess the clarity of the user specification based on various factors and assign a clarity score to the user specification. In some embodiments, the clarity score may be used to determine if the user specification comprises adequate information (e.g., in quality and quantity) to engineer a prompt for one or more generative AI systems. For example, a computed clarity score may need to match or exceed a predetermined threshold value to be submitted to a prompt engineering subsystem.

A design cache 205 is present and configured to capture and temporarily store user specifications, user design choices, responses to wizard/chatbot, and a clarity score for a given user specification. This information may be periodically sent to and stored in design catalogue database 136. This information may be used to train or improve the one or more ML/AI/scoring models used by platform 100. For example, a scoring model may be improved by using historical user specification data with its assigned clarity score as well as user behavior/interaction data collected when the user interacts with the generated content, to improve its scoring capabilities by, for example, adjusting the weights assigned to one or more clarity factors.

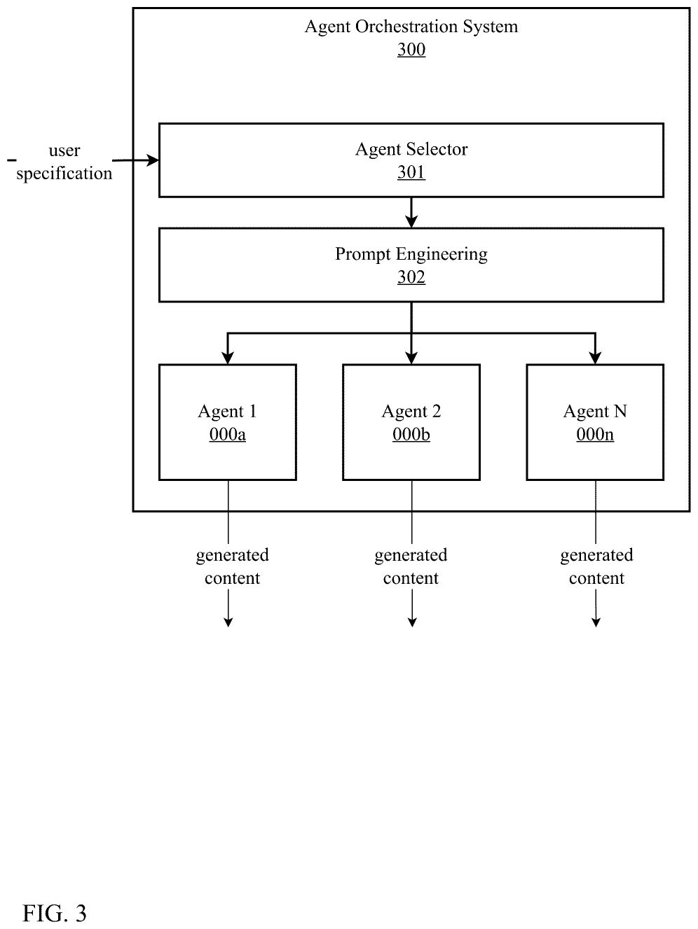

FIG. 3 is a block diagram illustrating an exemplary aspect of dynamic application experience generation platform, an agent orchestration system 300. According to the aspect, agent orchestration system 300 comprises an agent selector subsystem 301, a prompt engineering subsystem 302, and one or more agents 303a-n which represent one or more generative AI systems. According to the aspect, agent orchestration system 300 receives a user specification from design management system 200 via agent selector 301. Agent selector 301 may be configured to parse the user specification and select one or more appropriate generative AI systems (also referred to herein as agents) to generate the UX/UI content described by the user specification. The selection of the one or more agents may be based on various factors including, but not limited to, the user defined requirements (e.g., target audience, design goals, functionality, platform/device, etc.), generative AI (gen AI) system compatibility (e.g., using an LLM to generate text, diffusion models to generate images or sound, etc.), model performance (e.g., factors such as the quality of designs, the range of design options, and the ability to customize to meet the user's needs), model integration (e.g., models which can easily be integrated into existing workflows and tools), cost and licensing, and user/expert feedback (e.g., gathered feedback from stakeholders and iterate on design).

There are several generative AI systems that are used across various industries and there will be more generative AI systems that develop in the near future which may be incorporated into platform 100. Some notable examples of generative AI system that may be implemented by platform include transformers and its variants (e.g., autoregressive), neural networks and its variants (e.g., convolutional neural network, recurrent neural network), generative adversarial networks (GANs), image recognition, image editing, natural language understanding, and/or the like. For example, a large language model may be selected to generate textual content for a UX/UI and a convolutional neural network to perform text-to-image synthesis for a UX/UI. Examples of generative AI systems can further include OpenAI's GPT models, DeepArt.io, RunwayML, Google's DeepDream, Artbreeder, and various others.

Agents may be selected based on the platform the UX/UI needs to be displayed on. Once the proper agents have been selected, the user specification may be sent to prompt engineering subsystem 302. Prompt engineering is a process used to design prompts or instructions that guide the behavior of generative AI systems. It involves crafting specific inputs that help the model understand the desired task or context and generate relevant content. The first step is to clearly define the task or goal the user wants the agents to perform. This could be anything from answering a question to summarizing a text or generating creative content. Based on the task, prompt engineering subsystem 302 designs a prompt that provides the necessary context for the agent(s). The prompt should be clear, concise, and include any relevant information or examples that the model needs to generate a response. In some implementations, system 200 may experiment with different prompts and parameters to see how they affect the model's performance. This may involve adjusting the length of the prompt, the type of information included, and other factors. Additionally, system 200 can test the agent(s) with different prompts to evaluate their performance. This could involve measuring the accuracy of its responses, its ability to generalize to new tasks, and other metrics. Overall, prompt engineering is an iterative process that involves designing and refining prompts to help generative AI systems perform specific tasks (e.g., UX/UI content generation) effectively.

The one or more selected agents 303a, 303b, and 303n may be fed as inputs the engineered prompt to generate UX/UI content based on the user specification. In some embodiments, prompt engineering subsystem 302 may be configured to only generate prompts for user specifications that have a sufficient clarity score. For example, a predetermined threshold value may need to be met or surpassed for prompt engineering system 302 to generate a prompt.

In some implementations, each agent may be given modified versions of the same prompt. A first agent 303a may generate a first design variation based on user preferences and user specification. A second agent 303b may generate a second design variation and so on for each operational agent. This provides designers with multiple options to choose from. Designers may provide feedback on generated designs and request iterations or adjustments as needed. This feedback may be used to improve the agent's ability to generate designs that meet the user expectations. In some implementations, the designers may export generated designs in standard formats (e.g., PSD, Sketch, HTML/CSS, etc.) for further customization or integration into their projects. For example, platform 100 may be integrated with popular design tools and platforms to streamline the design workflow for designers.

Platform 100 can provide cross platform UX/UI content generation responsive to user specification. A user may specify the types of devices/platforms on which their designed UX/UI should be generated for. For example, a user specification may indicate that the UX/UI should be generated for websites, mobile device applications, and smart wearable devices. Agent(s) 303a-n may then generate computer code in various coding languages to implement the design criteria represented in the user specification. For creating the structure and content of web pages Hypertext Markup Language (HTML) code may be generated as well as Cascading Style Sheets (CSS) code for styling the appearance of web pages, including layout, colors, and fonts, and JavaScript code for adding interactivity and dynamic behavior to web pages, such as animations, form validation, and user interface components. For mobile device applications, an agent can generate UX/UI for iOS using coding languages Swift or Objective-C. For Android devices the coding language may be Java or Kotlin. And for cross-platform the use of frameworks such as React Native, Flutter, and Xamarin to generate code that runs on both iOS and Android platforms. Many smart wearable devices have their own Software Development Kits (SDKs) and development environments, for example, WatchKit with Swift or Objective-C. The selection of the appropriate coding language the agents will use to generate UX/UI content is based on the information provided in the user specification. In addition to these languages, technologies, and frameworks, the generative AI systems may also be trained on specific tools and libraries for each platform and device to create effective UX/UI designs and ensure compatibility and performance. This can enable everyday users to generate significantly more effective workflows/sites. This also enables not just “concept to code” mapping for users but ongoing site evolution. For example, link the site performance (e.g., load times, observability, etc.) with conversion rates and site metrics (e.g., shopping checkouts/revenue and site analytics on time per page, etc.) and more detailed user click/trace/eye tracking elements the system can provide programmatic A/B testing.

A/B testing and monitoring site performance is a useful element for generative AI workflows and on the fly customization since metrics such as load times might encourage image or content compression, size changes, etc. to get to superior performance, even in case with network instability, to result in more efficient commercial conversion. As it relates to advertisements, the system may leverage other demographic or contextual factors to change “sets” of things such as, for example, image/word combinations (e.g., a consumer estimated to be a hippy kind of persona might get “all natural” and “green” language and imagery where a science focused consumer might see “lab coats” and equipment/science text/arguments. This can evolve during the session or across sessions with a single user or group of users and can be related to the site owner for suggestions or approvals of content experiences or paths that might lead to engagement or conversion goals of interest.

It is also possible to allow the users (not the owner of designer) to directly modify their content/experience. By allowing users to interact with chatbot 202 they would have the ability to make requests and ask information about a particular site or site element/content. The AI agent could then use this information to dynamically modify or navigate the site in a way that is organic and tailored to this particular user's needs and preferences for engagement (e.g., browser vs. a search vs. an explorer etc.). This process can also happen automatically by observing user behavior in real time. The system could learn and adapt to how a user browses a website (or application), and with enough users also learn the most common things these users need to do. Dynamically reshaping a page to suit these needs not only would make the user experience drastically more efficient, but may negate the need for any UI/UX humans. By allowing the UX workflow to be generated by a model after observing ongoing usage patterns, novel new architectures and design patterns can emerge. Experts, users, designer and engineer feedback maybe collected and implemented as feedback loops to improve model results.

In an embodiment, dynamic application experience generation platform 100 may utilize a domain-specific language (DSL) to enable designers to define cross-platform experiences at a high level of abstraction. The DSL provides a structured, purposeful syntax for specifying experiential elements, content elements, design elements, cross-platform targeting, AI integration, and analytics and optimization.

Experiential elements in the DSL allow designers to define the desired user experience in terms of goals, context, preferences, workflows, and interactivity requirements. For example, a designer could specify that the goal of a particular screen is to allow users to quickly find and purchase a product, with the context being that the user has already viewed similar products. The DSL syntax for this might look like:
experience:
goal: quick_product_purchase
context: similar_products_viewed
workflow:
view_product_details
add_to_cart
proceed_to_checkout

Content elements in the DSL enable designers to define the types of content needed (e.g., text, images, video, audio), content requirements, and how content should be structured and presented to the user. For instance, a designer could specify that a product detail screen should include a title, description, image gallery, and customer reviews. The DSL syntax for this might look like:
content:
product_details:
title: string
description: string
images: array(image)
reviews: array(review)

Design elements in the DSL provide primitives for common UI components and design patterns, such as layouts, navigation, input controls, and information architecture. Designers can also specify branding, visual style, and accessibility requirements. For example, a designer could define a consistent header layout with a logo, navigation menu, and search bar. The DSL syntax for this might look like:
design:
header:
layout: horizontal
components:
logo: image
navigation: menu
search: input
branding:
color: #001F3F
font_family: Helvetica

Cross-platform targeting in the DSL allows designers to specify the different devices and platforms to target, such as web, mobile, AR/VR, and wearables. The DSL provides abstractions to define the experience and design in a platform-agnostic way, with the underlying system handling the translation to platform-specific implementations. For example, a designer could specify that a particular experience should be optimized for both web and mobile platforms. The DSL syntax for this might look like:
platforms:
web
mobile

AI integration in the DSL can be achieved through hooks that allow designers to specify how generative AI should be used for content creation, experience personalization, and predictive UX optimizations. Designers can provide AI training data, prompts, and tuning factors within the DSL. For example, a designer could specify that product descriptions should be generated using AI, based on a set of keywords and a tone of voice. The DSL syntax for this might look like:
ai:
product_descriptions:
generator: gpt-4
prompt: “Generate a persuasive product description based on the following keywords:
{keywords}. Use a {tone}tone of voice.”
training_data: product_catalog
tuning:
temperature: 0.7
max_length: 200

Analytics and optimization in the DSL allow designers to define user journey tracking, funnel analysis, a/b testing, and UX metrics. Designers can specify how the experience should optimize itself based on analytics data. For example, a designer could define a goal funnel for a checkout process and specify that the system should automatically test different button colors to optimize for conversion. The DSL syntax for this might look like:
analytics:
goal_funnel:
view_product
add_to_cart
start_checkout
complete_purchase
optimization:
checkout_button:
variant: button_color
metric: conversion_rate

By combining these various elements of the DSL, designers can define rich, interactive, and optimized cross-platform experiences at a high level of abstraction. The dynamic application experience generation platform then interprets this DSL code and translates it into the necessary underlying system calls and API interactions with the design management system, agent orchestration system, analytics system, and/or other components to generate and optimize the actual application experience.

The DSL may include primitives for specifying how generative AI models 303a-n should be used for content creation, experience personalization, and predictive UX optimizations. These primitives could map to specific API calls or configuration settings for the AI models, allowing designers to control their behavior and output. Similarly, the DSL may provide primitives for specifying analytics tracking, testing, and optimization, which would map to corresponding functionality in the analytics system 133.

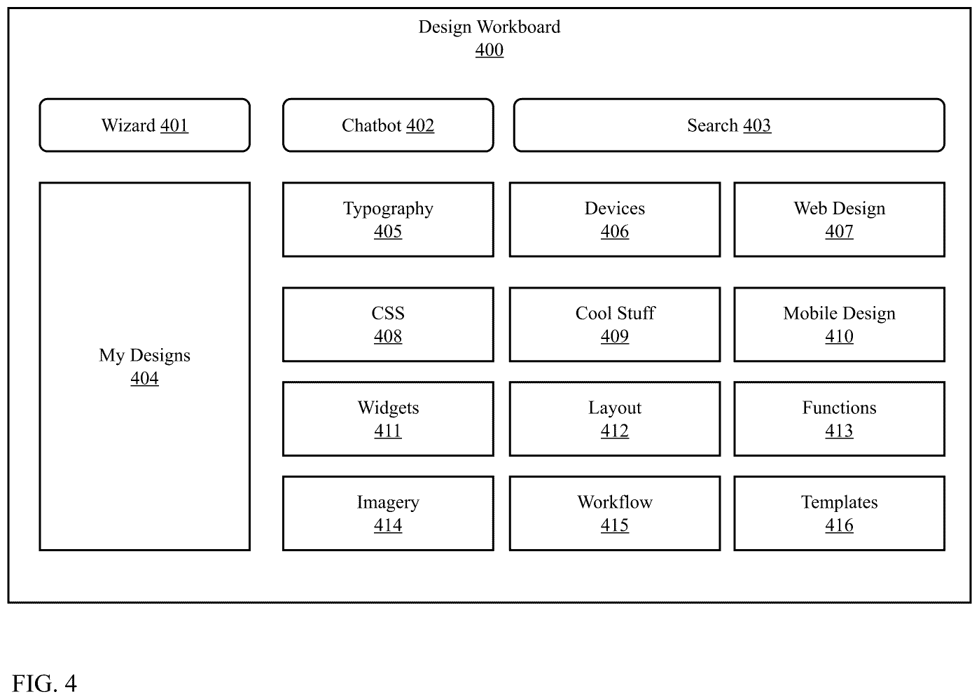

FIG. 4 is a block diagram illustrating an exemplary design workboard 400 which may be implemented by dynamic application experience generation platform, according to an aspect. The design portal 203 and design library 204 may be integrated to provide the user with graphic user interface in which they can browse, search, and preview a plurality of templates and design elements. According to the aspect, designers can access wizard 401 or chatbot 402 to assist them with the design process and to construct a user specification. A search bar 403 is present which allows designers to search for templates and/or design elements. For example, a designer may conduct a search for templates related to health and fitness websites/applications. As another example, the designer could search for a specific design element such as accordion menus. The workboard may obtain the display and/or search results from design catalogue database 136. A search may be performed on all available design elements/templates. A search may be performed within a specific category 404-416 of design elements/templates.

A shown, workboard 400 may display various templates and design elements 405-416. Additionally, workboard 400 can display a designer's previous or in-progress designs 404 allowing the designer to use previous designs as a starting point for new or updated content. Examples of design elements which may be displayed on workboard 400 can include, but are not limited to, typography 405, devices 406 (e.g., device-specific design elements/templates), web design 407 (e.g., templates of different categories of websites), CSS 408 (e.g., templates of different CSS designs), cool stuff 409 (which may be a user curated list of design elements/templates the user has “liked”, “tagged”, or otherwise indicated that they would like to add the content to their curated list), mobile design 410 (e.g., templates of mobile device applications), widgets 411, layout 412, functions 413 (e.g., different functionality provided by various websites), imagery 414 (e.g., types of images displayed in UX/UI content), workflow 415 (e.g., examples of different types of workflows), and templates 416 which may comprise all available templates.

In some implementations, user behavior during and interactions with design workboard 400 may be monitored and collected by platform 100 and used to improve one or more systems and functionalities provided by platform 100. For example, user design preferences may be inferred by a ML/AI model based on user behavior and interactions with workboard components such as user clicks, hover time, search queries, liked/tagged content, and/or the like.

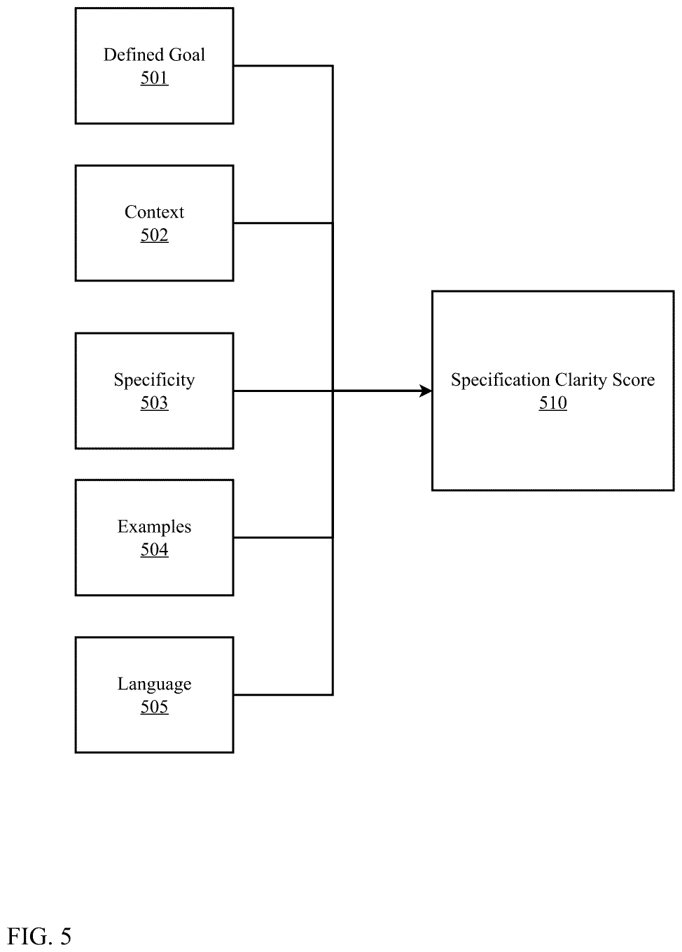

FIG. 5 is a block diagram illustrating exemplary clarity factors which may be used for determining a clarity score 510 associated with a user specification for UX/UI content, according to an aspect. The user in this case is a website/application owner and/or designer. According to the aspect of the embodiment, a design clarification subsystem 206 may compute a specification clarity score 510 based on multiple factors including but not limited to, one or more defined goals 501, specific context 502, a level of specificity 503, available examples 504, and the user's natural language 505. A general approach to crafting a prompt for generative AI system may involve obtaining a clearly defined goal of the prompt, or in other words, what the user wants the generative AI system to generate. This could be a text description, a piece of code, an image, or any other type of content. Generally, the user specification is directed to the goal of generating UX/UI content for an website/application. If the user's goal is not clearly defined, then the generative AI systems may produce output which is not relevant to the user's use case. Another scoring factor involves the use of specific context 502 which can provide relevant context to help the generative AI system understand the task. This could be background information, constraints, or requirements. Specific context may further comprise user preferences. For a more detailed description of the type of user preferences which may be incorporated into platform 100, refer to U.S. patent application Ser. No. 18/636,264 which is incorporated herein by reference. Some of the user preferences may allow selectable user privacy sharing of cookies and user released data that enables contextual ads and other services where valuable to user experience. For example, a user (website visitor) might get faster page loads or more downloads or content access for limited profile “unmasking: when they directly visit a website/application or a user's digital doppelganger does.

Another scoring factor can include the level of specificity 503 of the user specification. The user should be as specific as possible about what they want the generative AI system to generate. A check may be made for ambiguous or vague language that could lead to unexpected results. For example, the use of ambiguous or vague language may result in a lower clarity score. A chatbot may be configured to ask clarifying questions if a user response to a chatbot inquiry is vague or overly technical.

If possible, the user specification can include examples 504 of the desired output to give to the generative AI systems a clear reference point. For example, a user selected template or design elements from the catalogue of templates/design elements can be used as an example for the generative AI systems. Additionally, the language 505 of the user specification may be evaluated as a component of the clarity score. When crafting a prompt, it is important to use natural language that is easy for the generative AI systems to understand. The inclusion of unnecessary complex or technical language may result in a reduced clarity score.

In some implementations, the clarity score(s) 510 may be based on aggregated scores assigned to each of multiple scoring factors. In some implementations, each scoring factor may be assigned a weight or some other coefficient value which determines the relative importance of each factor in calculating the total clarity score. For example, if the defined goals factor 501 has a score of eight and a weight of 0.3, the weighted score for the defined goals factor is 8*0.3=2.4. Each of these weighted scores may be added up for all factors to yield the total clarity score. Incorporating weights allows the system to emphasize certain factors over others based on their importance in the overall scoring system. Importance may be determined in various ways. Factors with higher weights contribute more to the total score, while factors with lower weights have less influence. A first way may be user defined importance which is communicated by the user to the system via wizard 201 or chatbot 202. Another way to determine importance may be by observing user behavior when interacting with the system and the generated content to infer and/or derive the importance of one or more factors based on user behavior.

According to an aspect, after generating output from the one or more generative AI systems, the system reviews the results and may refine the prompt and/or clarity score if needed. Iterating on the prompt can help improve the quality of the output.

### Detailed Description of Exemplary Aspects

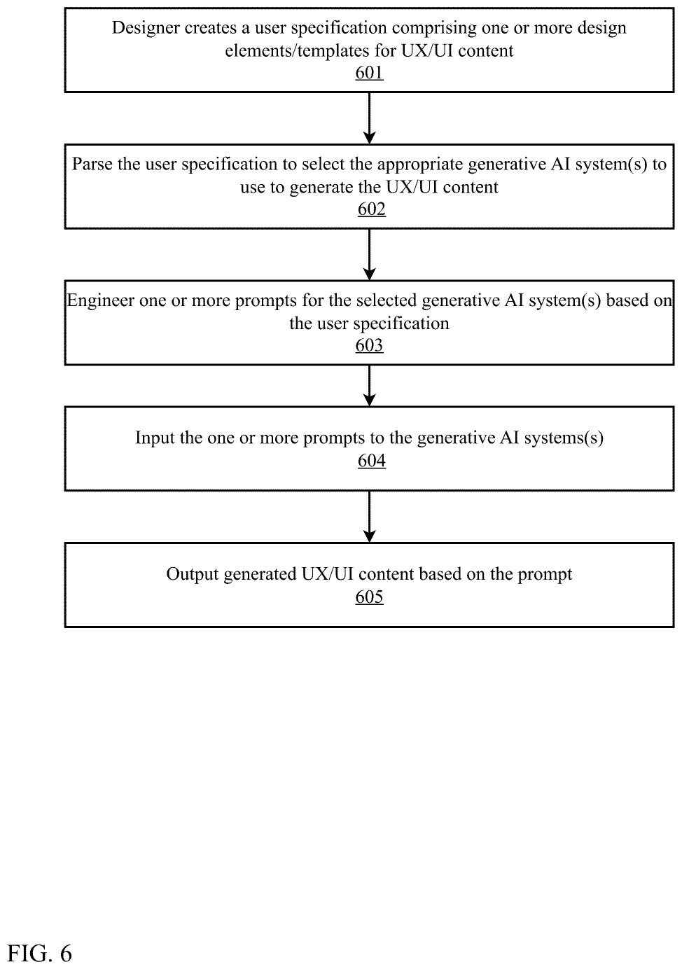

FIG. 6 is a flow diagram illustrating an exemplary method for generating UX/UI content and/or workflows using a user specification, according to an embodiment. According to the embodiment, the process begins at step 601 when a website or application owner/designer accesses design management system 200 to create a user specification comprising one or more design elements and/or templates for UX/UI content and/or workflows. The designer may browse and search a plurality of stored design elements, templates, and functionalities to create the user specification. In some embodiments, a design workboard 400 may be utilized to facilitate user browsing and searching of the stored elements, templates, and functionalities. The user specification may further comprise information related to design criteria such as, for example, the platforms or devices on which the generated UX/UI content is to be displayed on (e.g., website, mobile device application, augmented reality/virtual reality device, wearable device, etc.), a defined goal, additional context (e.g., preferences, capabilities, etc.), examples of content, coding languages, and various other types of information that may be useful for creating UX/UI content. In an embodiment, the user specification may be defined using a domain-specific language (DSL) that allows designers to specify experiential elements, content elements, design elements, cross-platform targeting, AI integration, and analytics & optimization at a high level of abstraction. The DSL code is then parsed and interpreted by the design management system to generate the appropriate user specification data structure.

At step 602, design management system 200 can parse the user specification to determine one or more appropriate generative AI systems (i.e., agents) to use to generate the UX/UI content. The selection of the one or more generative AI systems may be based on user specification information such as defined goals, coding language or framework, ease of integration with existing tools or workflows, and/or historical performance of various generative AI systems. At step 603 design management system 200 engineers one or more prompts for the selected generative AI system(s) based on the user specification. The one or more prompts may comprise slightly modified prompts. At step 604 the one or more prompts are input to the selected generative AI system(s). As a last step 605, the generative AI system outputs generated UX/UI content or workflow based on the prompt. UX/UI content refers to the textual and visual elements that make up the user interface and user experience of a digital product, such as a website, mobile app, or software application. This content includes text, images, videos, buttons, icons, menus, forms, and other interactive elements that users engage with to interact with the product. Good UX/UI content is clear, concise, and tailored to the needs and preferences of the target audience, enhancing the overall usability and user satisfaction of the product. A UX workflow refers to the series of steps that designers and developers follow to create a user experience design for a product, such as a website or mobile app. The workflow typically includes the following stages: research (e.g., gathering information about the target audience, market trends, and competitors to understand user needs and preferences), planning (e.g., define the project scope, objectives, and timeline, as well as create user personas and develop user stories), design (e.g., creating wireframes, mockups, and prototypes to visualize the user interface and user interactions), testing (e.g., conduct usability testing with real users to gather feedback and identify any issues or areas for improvement), iteration (e.g., based on the feedback from testing, make revisions to the design to address any issues and improve the user experience), launch (e.g., product is made available to users), and post-launch where continuous monitoring of user feedback and analytics is performed to make further improvements to the design.

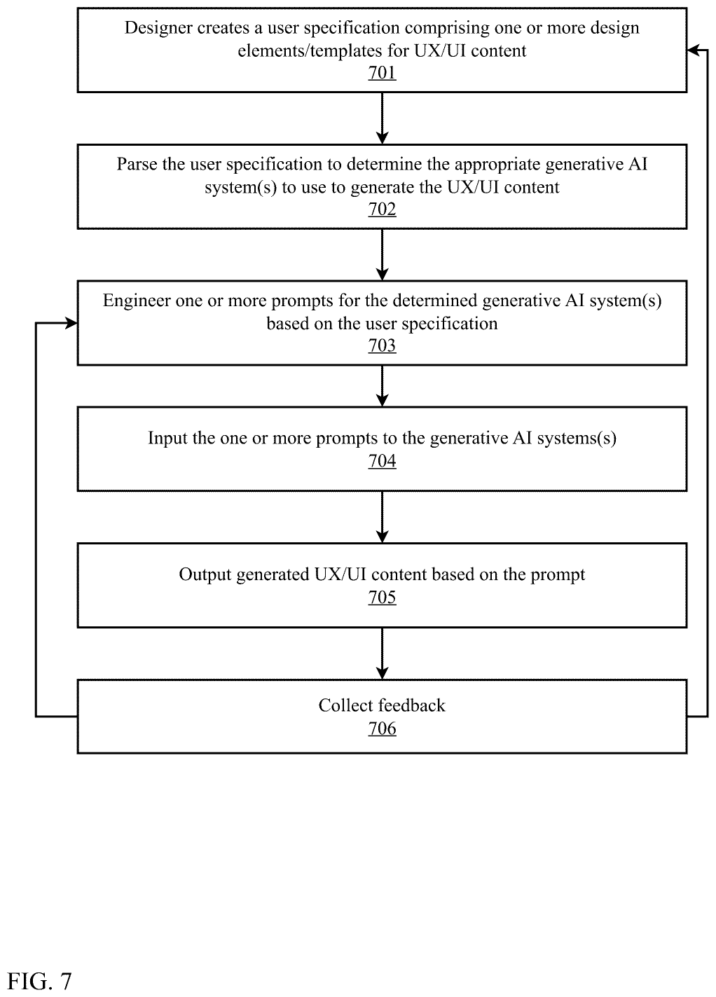

FIG. 7 is a flow diagram illustrating an exemplary method for generating UX/UI content and/or workflows using a user specification and feedback, according to an embodiment. According to the embodiment, the process begins at step 701 when a website or application owner/designer accesses design management system 200 to create a user specification comprising one or more design elements and/or templates for UX/UI content and/or workflows. The designer may browse and search a plurality of stored design elements, templates, and functionalities to create the user specification. In some embodiments, a design workboard 400 may be utilized to facilitate user browsing and searching of the stored elements, templates, and functionalities. The user specification may further comprise information related to design criteria such as, for example, the platforms or devices on which the generated UX/UI content is to be displayed on (e.g., website, mobile device application, augmented reality/virtual reality device, wearable device, etc.), a defined goal, additional context (e.g., preferences, capabilities, etc.), examples of content, coding languages, and various other types of information that may be useful for creating UX/UI content.

At step 702, design management system 200 can parse the user specification to determine one or more appropriate generative AI systems (i.e., agents) to use to generate the UX/UI content. The selection of the one or more generative AI systems may be based on user specification information such as defined goals, coding language or framework, ease of integration with existing tools or workflows, and/or historical performance of various generative AI systems. At step 703 design management system 200 engineers one or more prompts for the selected generative AI system(s) based on the user specification. The one or more prompts may comprise slightly modified prompts. At step 704 the one or more prompts are input to the selected generative AI system(s). As a next step 705, the generative AI system outputs generated UX/UI content or workflow based on the prompt.

As a last step 706 the platform 100 collects a plurality of feedback to evaluate the generative AI systems output. Feedback may be collected from application users. Feedback may be collected from experts such as UX/UI designers or experts related to the category of application/website (e.g., a fitness application may utilize fitness experts such as personal trainers and coaches to provide feedback on generated fitness application content). Feedback may be collected from user behavior and/or interactions with the generated content. The collected feedback information may be used to improve prompt engineering functionality. For example, if the generated output does not quite capture the idea the designer had in mind when making the user specification, then feedback may be used to improve or iterate on the prompts to better capture the designer's intent or vision. Similarly, the collected feedback can be used to improve the creation of the user specification. For example, generated content that is found to be useful or capture the intent of the designer may be templatized and saved so that the designer or future designers can search and reuses the generated content.

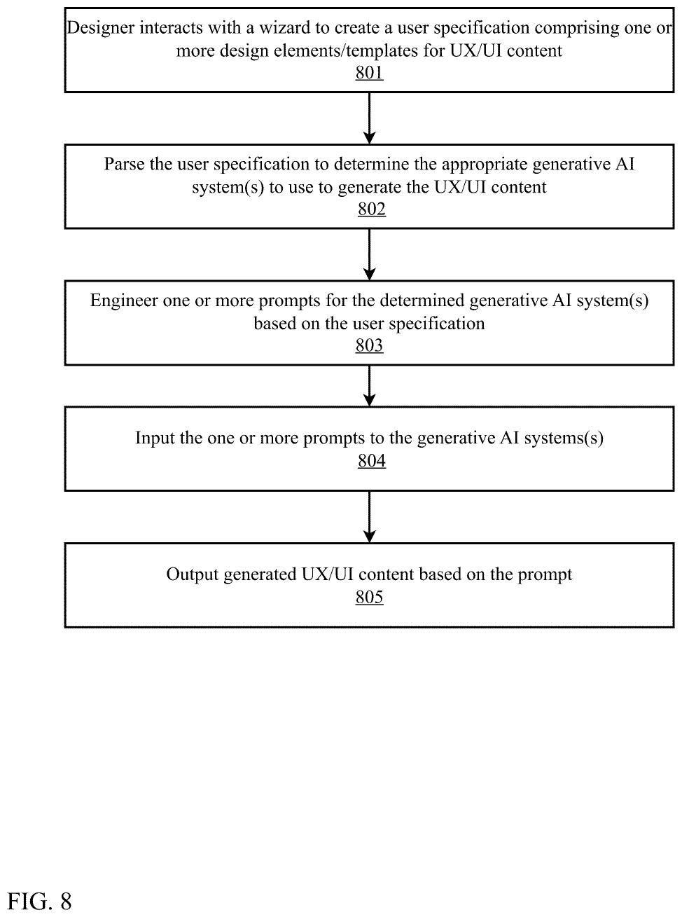

FIG. 8 is a flow diagram illustrating an exemplary method for generating UX/UI content and/or workflows using a user specification wizard, according to an embodiment. According to the embodiment, the process begins at step 801 when a website or application owner/designer accesses design management system 200 and interacts with a wizard to create a user specification comprising one or more design elements and/or templates for UX/UI content and/or workflows. The wizard might ask the user to provide information related to the project overview (e.g., purpose and desired outcome), target audience (e.g., their demographics, preferences, and behaviors), functionality requirements (e.g., specific features, unique elements, etc.), content requirements (e.g., type of content such as images, text, videos, sound, and how it should be presented), branding guidelines, design preferences, interaction patterns, accessibility requirements, device compatibility (e.g., should the design be optimized for specific devices), and timeline and budget details. By gathering this information, the software wizard can create a comprehensive user specification that can be used to generate UX/UI content using a generative AI system. In some implementations, the wizard may guide the designer through the process of defining the user specification using the DSL. The wizard could provide a graphical interface for constructing the DSL code, with form fields, dropdown menus, and other controls for specifying the various elements of the experience. Alternatively, the wizard could prompt the designer to write the DSL code directly, with syntax highlighting, autocompletion, and other code editing aids.

Additionally, the designer may browse and search a plurality of stored design elements, templates, and functionalities to create the user specification. In some embodiments, a design workboard 400 may be utilized to facilitate user browsing and searching of the stored elements, templates, and functionalities. The user specification may further comprise information related to design criteria such as, for example, the platforms or devices on which the generated UX/UI content is to be displayed on (e.g., website, mobile device application, augmented reality/virtual reality device, wearable device, etc.), a defined goal, additional context (e.g., preferences, capabilities, etc.), examples of content, coding languages, and various other types of information that may be useful for creating UX/UI content.

At step 802, design management system 200 can parse the user specification to determine one or more appropriate generative AI systems (i.e., agents) to use to generate the UX/UI content. The selection of the one or more generative AI systems may be based on user specification information such as defined goals, coding language or framework, ease of integration with existing tools or workflows, and/or historical performance of various generative AI systems. At step 803 design management system 200 engineers one or more prompts for the selected generative AI system(s) based on the user specification. The one or more prompts may comprise slightly modified prompts. At step 804 the one or more prompts are input to the selected generative AI system(s). As a last step 805, the generative AI system outputs generated UX/UI content or workflow based on the prompt.

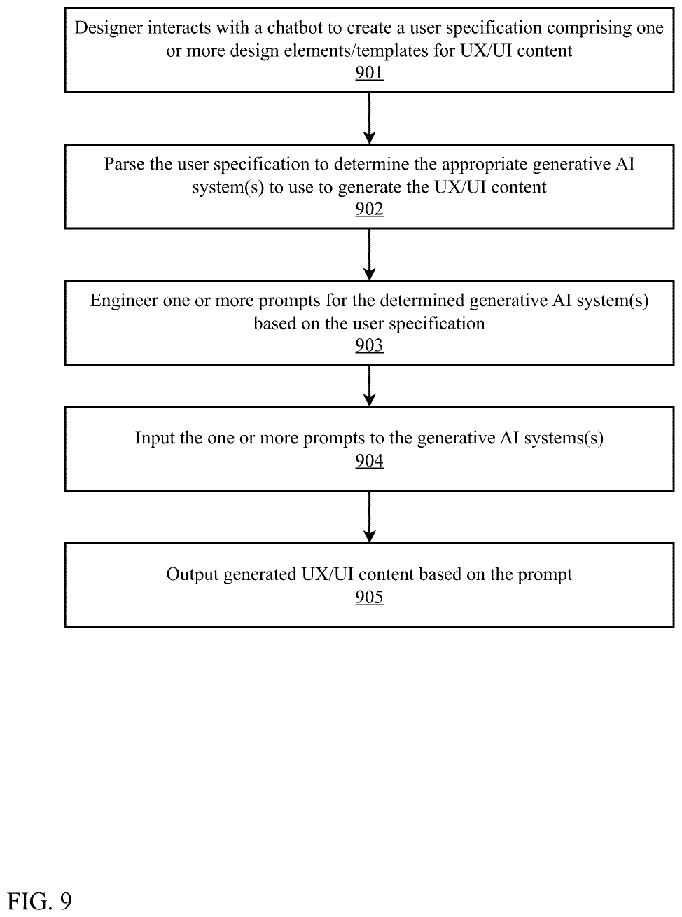

FIG. 9 is a flow diagram illustrating an exemplary method for generating UX/UI content and/or workflows using a user specification chatbot, according to an embodiment. According to the embodiment, the process begins at step 901 when a website or application owner/designer accesses design management system 200 and interacts with a chatbot to create a user specification comprising one or more design elements and/or templates for UX/UI content and/or workflows. The chatbot may be based on a transformer model similar to an LLM and might ask the user to provide information related to the project via a series of questions and responses from the user. For example, the chatbot may gather information related to the project overview (e.g., purpose and desired outcome), target audience (e.g., their demographics, preferences, and behaviors), functionality requirements (e.g., specific features, unique elements, etc.), content requirements (e.g., type of content such as images, text, videos, sound, and how it should be presented), branding guidelines, design preferences, interaction patterns, accessibility requirements, device compatibility (e.g., should the design be optimized for specific devices), and timeline and budget details. By gathering this information, the chatbot and user can create a comprehensive user specification that can be used to generate UX/UI content using a generative AI system.

Additionally, the designer may browse and search a plurality of stored design elements, templates, and functionalities to create the user specification. In some embodiments, a design workboard 400 may be utilized to facilitate user browsing and searching of the stored elements, templates, and functionalities. The user specification may further comprise information related to design criteria such as, for example, the platforms or devices on which the generated UX/UI content is to be displayed on (e.g., website, mobile device application, augmented reality/virtual reality device, wearable device, etc.), a defined goal, additional context (e.g., preferences, capabilities, etc.), examples of content, coding languages, and various other types of information that may be useful for creating UX/UI content. The chatbot could also assist the designer in constructing the user specification using the DSL. The designer could provide the chatbot with a high-level description of the desired experience, and the chatbot could generate the corresponding DSL code. The chatbot could then explain the generated code to the designer and allow them to iteratively refine it through further conversation.

At step 902, design management system 200 can parse the user specification to determine one or more appropriate generative AI systems (i.e., agents) to use to generate the UX/UI content. The selection of the one or more generative AI systems may be based on user specification information such as defined goals, coding language or framework, ease of integration with existing tools or workflows, and/or historical performance of various generative AI systems. At step 903 design management system 200 engineers one or more prompts for the selected generative AI system(s) based on the user specification. The one or more prompts may comprise slightly modified prompts. At step 904 the one or more prompts are input to the selected generative AI system(s). As a last step 905, the generative AI system outputs generated UX/UI content or workflow based on the prompt.

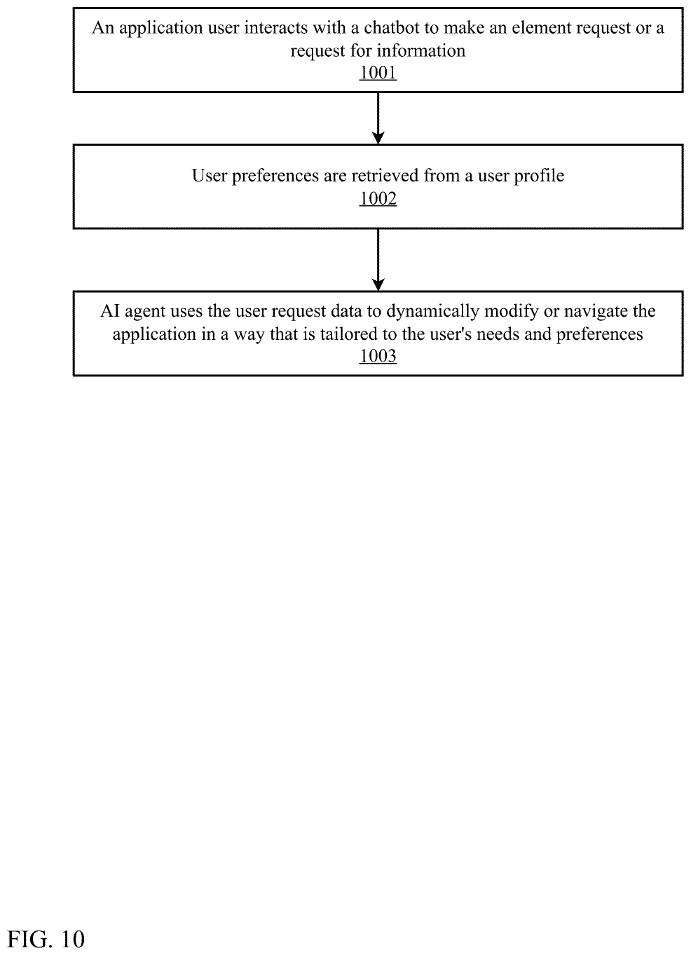

FIG. 10 is a flow diagram illustrating an exemplary method for providing dynamic UX/UI modification in real-time based on a user request, according to an embodiment. According to the embodiment, the process begins at step 1001 when an application user interacts with a chatbot to make an design element request or a request for information. At step 1002 the application user's preferences may be retrieved from a user profile which may be stored in a preference database. At step 1003, an AI agent (i.e., generative AI model) uses the user request data to dynamically modify or navigate the application in a way that is tailored to the user's needs and preferences.

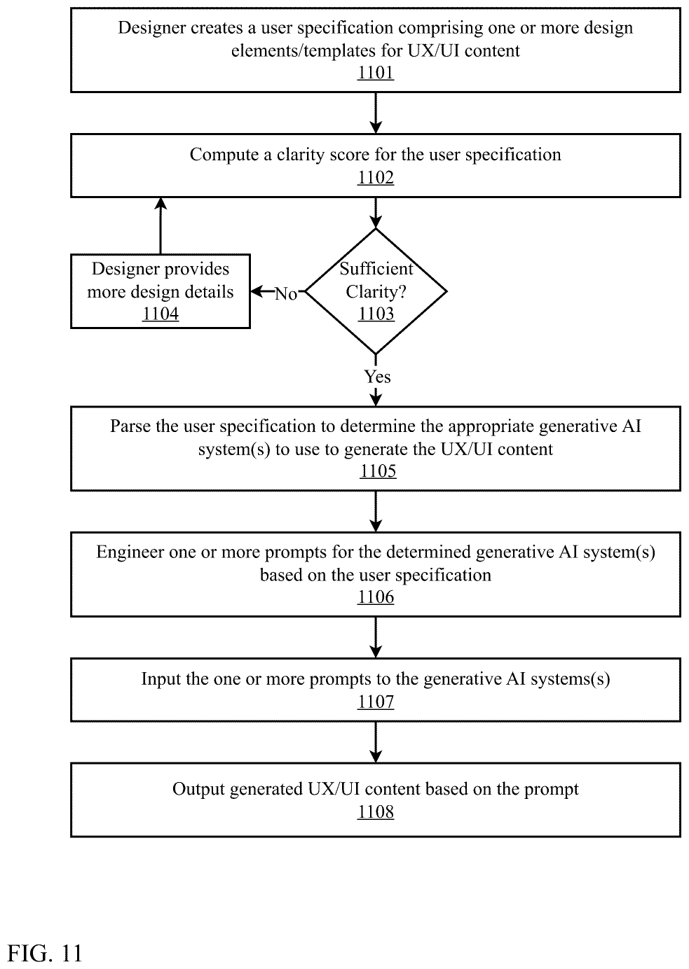

FIG. 11 is a flow diagram illustrating an exemplary method for generating UX/UI content and/or workflows using a user specification and a clarity score, according to an embodiment. According to the embodiment, the process begins at step 1101 when a website or application owner/designer accesses design management system 200 to create a user specification comprising one or more design elements and/or templates for UX/UI content and/or workflows. The designer may be assisted by the use of a software wizard and/or a chatbot. The designer may browse and search a plurality of stored design elements, templates, and functionalities to create the user specification. In some embodiments, a design workboard 400 may be utilized to facilitate user browsing and searching of the stored elements, templates, and functionalities. The user specification may further comprise information related to design criteria such as, for example, the platforms or devices on which the generated UX/UI content is to be displayed on (e.g., website, mobile device application, augmented reality/virtual reality device, wearable device, etc.), a defined goal, additional context (e.g., preferences, capabilities, etc.), examples of content, coding languages, and various other types of information that may be useful for creating UX/UI content.

At step 1102 design management system 200 computes a clarity score for the user specification. The clarity score may be based on a plurality of factors as described herein. At 1103 a check is made to determine if sufficient clarity in the user specification. This may be accomplished, for example, by comparing the computed clarity score to a predetermined threshold value and if the threshold value is exceeded then sufficient clarity has been met. If the user specification is not sufficient, then the process proceeds to step 1104 where the designer may provide more design details for the user specification and then a new clarity score is computed. If the user specification is sufficient, then the process proceeds to step 1105.

At step 1105, design management system 200 can parse the user specification to determine one or more appropriate generative AI systems (i.e., agents) to use to generate the UX/UI content. The selection of the one or more generative AI systems may be based on user specification information such as defined goals, coding language or framework, ease of integration with existing tools or workflows, and/or historical performance of various generative AI systems. At step 603 design management system 200 engineers one or more prompts for the selected generative AI system(s) based on the user specification. The one or more prompts may comprise slightly modified prompts. At step 604 the one or more prompts are input to the selected generative AI system(s). As a last step 605, the generative AI system outputs generated UX/UI content or workflow based on the prompt. UX/UI content refers to the textual and visual elements that make up the user interface and user experience of a digital product, such as a website, mobile app, or software application. This content includes text, images, videos, buttons, icons, menus, forms, and other interactive elements that users engage with to interact with the product. Good UX/UI content is clear, concise, and tailored to the needs and preferences of the target audience, enhancing the overall usability and user satisfaction of the product. A UX workflow refers to the series of steps that designers and developers follow to create a user experience design for a product, such as a website or mobile app. The workflow typically includes the following stages: research (e.g., gathering information about the target audience, market trends, and competitors to understand user needs and preferences), planning (e.g., define the project scope, objectives, and timeline, as well as create user personas and develop user stories), design (e.g., creating wireframes, mockups, and prototypes to visualize the user interface and user interactions), testing (e.g., conduct usability testing with real users to gather feedback and identify any issues or areas for improvement), iteration (e.g., based on the feedback from testing, make revisions to the design to address any issues and improve the user experience), launch (e.g., product is made available to users), and post-launch where continuous monitoring of user feedback and analytics is performed to make further improvements to the design.

### Exemplary Computing Environment

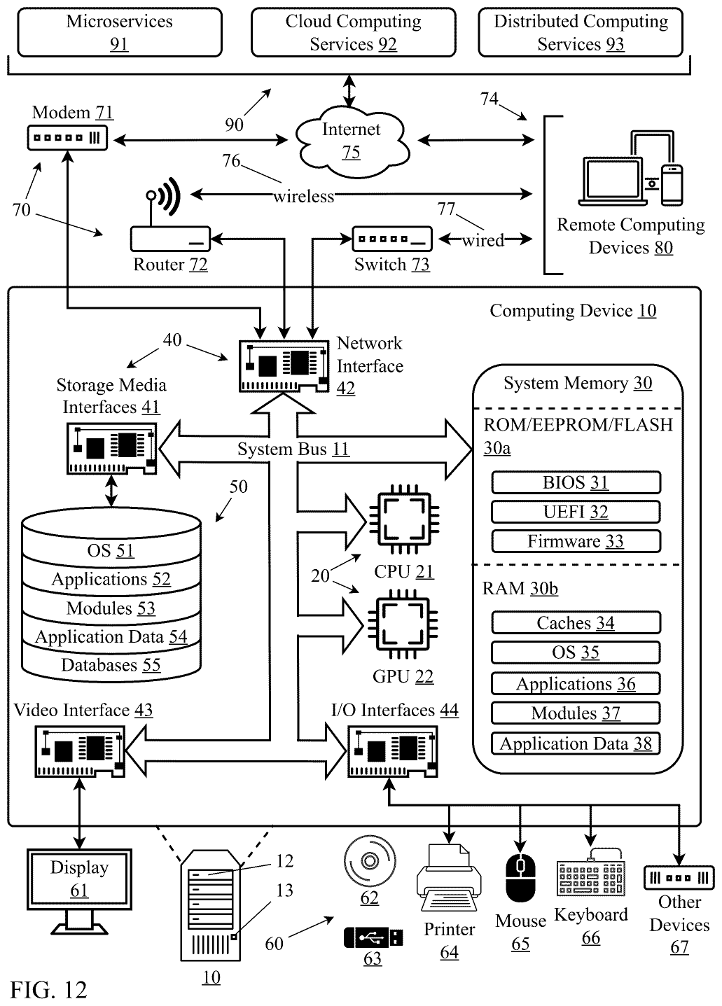

FIG. 12 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 12 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions based on technologies like CISC or RISC. Further, computing device 10 may comprise one or more specialized processors such as a graphics processing unit (GPU) 22 configured to accelerate processing of computer graphics and images via a large array of specialized processing cores arranged in parallel. The term processor may further include: neural processing units (NPUs) or neural computing units optimized for machine learning and artificial intelligence workloads using specialized architectures and data paths; tensor processing units (TPUs) designed to efficiently perform matrix multiplication and convolution operations used heavily in neural networks and deep learning applications; application-specific integrated circuits (ASICs) implementing custom logic for domain-specific tasks; application-specific instruction set processors (ASIPs) with instruction sets tailored for particular applications; field-programmable gate arrays (FPGAs) providing reconfigurable logic fabric that can be customized for specific processing tasks; processors operating on emerging computing paradigms such as quantum computing, optical computing, mechanical computing (e.g., using nanotechnology entities to transfer data), and so forth. Depending on configuration, computing device 10 may comprise one or more of any of the above types of processors in order to efficiently handle a variety of general purpose and specialized computing tasks. The specific processor configuration may be selected based on performance, power, cost, or other design constraints relevant to the intended application of computing device 10.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, NoSQL databases, and graph databases.

Applications (also known as computer software or software applications) are sets of programming instructions designed to perform specific tasks or provide specific functionality on a computer or other computing devices. Applications are typically written in high-level programming languages such as C++, Java, Scala, Rust, Go, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems.

In an embodiment, the dynamic application experience generation platform may include a DSL interpreter or compiler that translates the DSL code into executable instructions. The interpreter or compiler could be implemented as a separate module within the system, or it could be integrated into one of the existing components, such as the design management system or the agent orchestration system. The interpreter or compiler can parse the DSL code, validate its syntax and semantics, and generate the appropriate system calls and API interactions to realize the specified experience.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network. Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices.

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is Docker, which is widely used in software development and deployment. Containerization, particularly with open-source technologies like Docker and container orchestration systems like Kubernetes, is a common approach for deploying and managing applications. Containers are created from images, which are lightweight, standalone, and executable packages that include application code, libraries, dependencies, and runtime. Images are often built from a Dockerfile or similar, which contains instructions for assembling the image. Dockerfiles are configuration files that specify how to build a Docker image. Systems like Kubernetes also support containerd or CRI-O. They include commands for installing dependencies, copying files, setting environment variables, and defining runtime configurations. Docker images are stored in repositories, which can be public or private. Docker Hub is an exemplary public registry, and organizations often set up private registries for security and version control using tools such as Hub, JFrog Artifactory and Bintray, Github Packages or Container registries. Containers can communicate with each other and the external world through networking. Docker provides a bridge network by default, but can be used with custom networks. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, mainframe computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are serverless logic apps, microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP or message queues. Microservices 91 can be combined to perform more complex or distributed processing tasks. In an embodiment, Kubernetes clusters with containerd resources is used for operational packaging of system.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over public or private networks or the Internet on a subscription or alternative licensing basis.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power or support for highly dynamic compute, transport or storage resource variance over time requiring scaling up and down of constituent system resources. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, NVLink or other GPU-to-GPU high bandwidth communications links and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

What is claimed is:

1. A computing system for dynamic generation of application experience employing a dynamic application experience generation platform, the computing system comprising:
one or more hardware processors configured for:
receiving a user specification comprising one or more design elements, user preference configuration document, or templates associated with user experience (UX) or user interface (UI) content;
parsing the user specification to select one or more generative artificial intelligence (AI) systems to be used to generate the presented or intermediate UX or UI content;
engineering one or more prompts for the selected generative AI systems based on the user specification;
submitting the one or more prompts as input to the selected generative AI systems; and
outputting generating UX or UI content based on the submitted prompts.

2. The computing system of claim 1, wherein the one or more hardware processors are further configured for:
computing a clarity score for the user specification, wherein the clarity score is based on a plurality of factors;
comparing the computed clarity score with a predetermined threshold value:
wherein if the computed clarity score is less than the threshold value, collecting more design information from a designer to be added to the user specification; and
wherein if the computed clarity score matches or exceeds the threshold value, allowing the parsing of the user specification.

3. The computing system of claim 2, wherein the clarity plurality of factors comprises a defined goal, available context, specificity, content examples, and language.

4. The computing system of claim 1, wherein the generated UX or UI content comprises computer code.

5. The computing system of claim 1, wherein the generated UX content comprises a UX workflow.

6. The computing system of claim 1, wherein the UX or UI content is generated for a plurality of devices and platforms.

7. The computing system of claim 6, wherein the plurality of devices and platforms comprise a computer, a mobile computing device, augmented reality or virtual reality devices, gaming platforms, and wearable devices.

8. The computing system of claim 1, wherein the one or more design elements comprises colors, shapes, formats, functions, widgets, cards, tiles, panels, tabs, dropdown menus, accordion menus, sliders, form elements, icons, progress indicators, and dialog boxes.

9. The computing system of claim 1, wherein the user specification is defined using a domain-specific language (DSL) that includes primitives for specifying experiential elements, content elements, design elements, cross-platform targeting, AI integration, and analytics & optimization.

10. The computing system of claim 9, wherein the DSL includes primitives for specifying how generative AI models should be used for content creation, experience personalization, and predictive UX optimizations.

11. A computer-implemented method executed on a dynamic application experience generation platform for dynamic generation of application experience, the computer-implemented method comprising:
receiving a user specification comprising one or more design elements, user preference configuration document, or templates associated with user experience (UX) or user interface (UI) content;
parsing the user specification to select one or more generative artificial intelligence (AI) systems to be used to generate the presented or intermediate UX or UI content;
engineering one or more prompts for the selected generative AI systems based on the user specification;
submitting the one or more prompts as input to the selected generative AI systems; and
outputting generating UX or UI content based on the submitted prompts.

12. The computer-implemented method of claim 11, wherein the one or more hardware processors are further configured for:
computing a clarity score for the user specification, wherein the clarity score is based on a plurality of factors;
comparing the computed clarity score with a predetermined threshold value:
wherein if the computed clarity score is less than the threshold value, collecting more design information from a designer to be added to the user specification; and
wherein if the computed clarity score matches or exceeds the threshold value, allowing the parsing of the user specification.

13. The computer-implemented method of claim 12, wherein the clarity plurality of factors comprises a defined goal, available context, specificity, content examples, and language.

14. The computer-implemented method of claim 11, wherein the generated UX or UI content comprises computer code.

15. The computer-implemented method of claim 11, wherein the generated UX content comprises a UX workflow.

16. The computer-implemented method of claim 11, wherein the UX or UI content is generated for a plurality of devices and platforms.

17. The computer-implemented method of claim 16, wherein the plurality of devices and platforms comprise a computer, a mobile computing device, augmented reality or virtual reality devices, gaming platforms, and wearable devices.

18. The computer-implemented method of claim 11, wherein the one or more design elements comprises colors, shapes, formats, functions, widgets, cards, tiles, panels, tabs, dropdown menus, accordion menus, sliders, form elements, icons, progress indicators, and dialog boxes.

19. The computer-implemented method of claim 11, wherein the user specification is defined using a domain-specific language (DSL) that includes primitives for specifying experiential elements, content elements, design elements, cross-platform targeting, AI integration, and analytics & optimization.

20. The computer-implemented method of claim 19, wherein the DSL includes primitives for specifying how generative AI models should be used for content creation, experience personalization, and predictive UX optimizations.

21. A system for dynamic generation of application experience employing a dynamic application experience generation platform, comprising one or more computers with executable instruction that, when executed, cause the system to:
receive a user specification comprising one or more design elements, user preference configuration document, or templates associated with user experience (UX) or user interface (UI) content;
parse the user specification to select one or more generative artificial intelligence (AI) systems to be used to generate the presented or intermediate UX or UI content;
engineer one or more prompts for the selected generative AI systems based on the user specification;
submit the one or more prompts as input to the selected generative AI systems; and
output generating UX or UI content based on the submitted prompts.

22. The system of claim 21, wherein the one or more hardware processors are further configured for:
computing a clarity score for the user specification, wherein the clarity score is based on a plurality of factors;
comparing the computed clarity score with a predetermined threshold value:
wherein if the computed clarity score is less than the threshold value, collecting more design information from a designer to be added to the user specification; and
wherein if the computed clarity score matches or exceeds the threshold value, allowing the parsing of the user specification.

23. The system of claim 22, wherein the clarity plurality of factors comprises a defined goal, available context, specificity, content examples, and language.

24. The system of claim 21, wherein the generated UX or UI content comprises computer code.

25. The system of claim 21, wherein the generated UX content comprises a UX workflow.

26. The system of claim 21, wherein the UX or UI content is generated for a plurality of devices and platforms.

27. The system of claim 26, wherein the plurality of devices and platforms comprise a computer, a mobile computing device, augmented reality or virtual reality devices, gaming platforms, and wearable devices.

28. The system of claim 21, wherein the one or more design elements comprises colors, shapes, formats, functions, widgets, cards, tiles, panels, tabs, dropdown menus, accordion menus, sliders, form elements, icons, progress indicators, and dialog boxes.

29. The system of claim 21, wherein the user specification is defined using a domain-specific language (DSL) that includes primitives for specifying experiential elements, content elements, design elements, cross-platform targeting, AT integration, and analytics & optimization.

30. The system of claim 29, wherein the DSL includes primitives for specifying how generative AI models should be used for content creation, experience personalization, and predictive UX optimizations.

31. Non-transitory, computer-readable storage media having computer executable instruction embodied thereon that, when executed by one or more processors of a computing system employing a dynamic application experience generation platform for dynamic generation of application experience, cause the computing system to:
receive a user specification comprising one or more design elements, user preference configuration document, or templates associated with user experience (UX) or user interface (UI) content;
parse the user specification to select one or more generative artificial intelligence (AI) systems to be used to generate the presented or intermediate UX or UI content;
engineer one or more prompts for the selected generative AI systems based on the user specification;
submit the one or more prompts as input to the selected generative AI systems; and
output generating UX or UI content based on the submitted prompts.

32. The non-transitory, computer-readable storage media of claim 31, wherein the one or more hardware processors are further configured for:
computing a clarity score for the user specification, wherein the clarity score is based on a plurality of factors;
comparing the computed clarity score with a predetermined threshold value:
wherein if the computed clarity score is less than the threshold value, collecting more design information from a designer to be added to the user specification; and
wherein if the computed clarity score matches or exceeds the threshold value, allowing the parsing of the user specification.

33. The non-transitory, computer-readable storage media of claim 32, wherein the clarity plurality of factors comprises a defined goal, available context, specificity, content examples, and language.

34. The non-transitory, computer-readable storage media of claim 31, wherein the generated UX or UI content comprises computer code.

35. The non-transitory, computer-readable storage media of claim 31, wherein the generated UX content comprises a UX workflow.

36. The non-transitory, computer-readable storage media of claim 31, wherein the UX or UI content is generated for a plurality of devices and platforms.

37. The non-transitory, computer-readable storage media of claim 36, wherein the plurality of devices and platforms comprise a computer, a mobile computing device, augmented reality or virtual reality devices, gaming platforms, and wearable devices.

38. The non-transitory, computer-readable storage media of claim 31, wherein the one or more design elements comprises colors, shapes, formats, functions, widgets, cards, tiles, panels, tabs, dropdown menus, accordion menus, sliders, form elements, icons, progress indicators, and dialog boxes.

39. The non-transitory, computer-readable storage media of claim 31, wherein the user specification is defined using a domain-specific language (DSL) that includes primitives for specifying experiential elements, content elements, design elements, cross-platform targeting, AI integration, and analytics & optimization.

40. The non-transitory, computer-readable storage media of claim 39, wherein the DSL includes primitives for specifying how generative AI models should be used for content creation, experience personalization, and predictive UX optimizations.
